(19) United States
(12) Patent Application Publication
(10) Pub. No.: US 2011/0179579 A1
(43) Pub. Date: Jul. 28, 2011

(54) EXPANDABLE EDGE-SUPPORT MEMBERS, ASSEMBLIES, AND RELATED METHODS, SUITABLE FOR BEDDING AND SEATING APPLICATIONS AND INNERSPRINGS

(75) Inventors: Randal Lee Henderson, Zebulon, NC (US); Timothy Michael Witherell, Gastonia, NC (US); Christopher Dean Page, Nashville, NC (US)

(73) Assignee: NOMACO INC., Zebulon, NC (US)

(21) Appl. No.: 12/694,562

(22) Filed: Jan. 27, 2010

(51) Int. Cl. A47C 23/05; B68G 7/00

(52) U.S. Cl. 5/717; 29/91.1

(57) ABSTRACT

Expandable edge-support members, assemblies, and related methods are disclosed. The expandable edge-support members can be used to provide edge support, including side support and corner support. The expandable edge-support members are suitable for bedding and seating applications as examples. The expandable edge-support members are expandable in length. Thus, the expandable edge-support members can be expanded in length as needed to be utilized to provide edge support for an innerspring having variations in perimeter lengths and different types of innersprings having variations in perimeter lengths. Further, the edge-support members may include a plurality of lateral members, which may be configured to be disposed between adjacent perimeter coils of an innerspring to support attachment to the innerspring. Thus, expansion of the expandable edge-support members can also allow the spacings between lateral members to be adjusted, including to fit between adjacent perimeter coils which may have variations in spacings in an innerspring.

### BACKGROUND

1. Field of the Disclosure

The technology of the disclosure relates to edge-support members, assemblies, systems, and related methods, and which may be employed in bedding and seating applications to provide support, including but not limited to side support and corner support.

2. Technical Background

Innerspring assemblies for mattresses or seating structures can be composed of a plurality of spring coils tied together in a matrix or array. An example of such an innerspring assembly is illustrated by the mattress 10 of FIG. 1. As illustrated therein, a mattress innerspring 12 (also called “innerspring 12”) is provided. The innerspring 12 is comprised of a plurality of traditional coils 14 arranged in an interconnected matrix to form a flexible core structure and support surfaces of the mattress. The coils 14 are also connected to each other through interconnection helical wires 16. Upper and lower border wires 18, 20 are attached to upper and lower end turns of the coils 14 at the perimeter of the array to create a frame for the innerspring 12. The upper and lower border wires 18, 20 also create firmness for edge support on the perimeter of the innerspring 12 where an individual may disproportionally place force on the innerspring 12, such as during mounting onto and dismounting from the mattress 10. The innerspring 12 is disposed on top of a box spring 22 to provide base support.

With regard to an edge 23 of the innerspring 12, there are some general considerations regarding construction and manufacture. In normal use, the edge 23 is subjected to greater compression forces that an interior 24 of the innerspring 12 due to the common practice of sitting on the edge 23 of the mattress 10. The coils 14 located proximate to the edge 23 of the innerspring 12 are subjected to concentrated loads as opposed to coils 14 located in the interior 24. To provide further perimeter structure and edge-support for the innerspring 12, support members 25 may be disposed around the coils 14 disposed proximate to the edge 23 of the innerspring 12 between the box spring 22 and the upper and lower border wires 18, 20. The support members 25 may be extruded from polymer-foam as an example. One or more layers of sleeping surface or padding material 26 can be disposed on top of the innerspring 12, and upholstery 27 is placed around the entire padding material 26, innerspring 12, and box spring 22 to provide a fully assembled mattress 10. This mattress structure in FIG. 1 may also be provided for other types of innersprings, including pocketed coils.

The dimensions of the innerspring support members 25 must be manufactured to be compatible with the size of the innerspring 12. For example, the length of the innerspring support members 25 must be properly sized to extend along the edge 23 of the innerspring 12 without extending beyond the corner 28 such that the innerspring support members 25 can be properly encased within the upholstery 27, as shown in FIG. 1. Further, the innerspring support members 25 should be sufficiently engaged with the innerspring 12 to provide stability and a uniform sleep surface for the mattress 10 between the edge 23 and the interior 24. Interlocking devices or members (not shown) may also be provided to secure innerspring support members 25 to the innerspring 12. These interlocking devices or members may be separate or integrally formed in the innerspring support members 25. It may be desired to provide interlocking devices or members that engage between adjacent coils 14 of the innerspring 12 to secure the innerspring support members 25 with the innerspring 12. However, spacing between adjacent coils 14 in the innerspring 12 can vary, thereby causing compatibility problems between innerspring support members 25 and different innersprings 12.

Thus, it would be desirable to provide edge-support that is compatible with an innerspring having varying lengths forming the innerspring perimeter. It would also be desirable to provide edge-support that is compatible with different types of innersprings that may have variations in perimeter lengths between the different types of innersprings. It would also be desirable to provide edge-support for an innerspring that has perimeter coils having varying spacings between adjacent perimeter coils. It would also be desirable to provide edge-support that is compatible with different types of innersprings that may have variations in spacings between adjacent perimeter coils between the different types of innersprings.

### SUMMARY OF THE DETAILED DESCRIPTION

Embodiments in the detailed description include expandable edge-support members, assemblies, and related methods. The expandable edge-support members can be used to provide edge support, including side support and corner support, for an innerspring. The expandable edge-support members, assemblies, and related methods are suitable for bedding and seating applications as examples. The expandable edge-support members are expandable in length. By being expandable in length, the expandable edge-support members can be expanded as needed to be utilized to provide edge support for an innerspring having variations in perimeter lengths. Further, the expandable edge-support members may be utilized for different types of innersprings having variations in perimeter lengths between the different types of innersprings. Further, the expandable edge-support members may include a plurality of lateral members that are configured to be disposed between adjacent perimeter coils of an innerspring to support attachment of the expandable edge-support members to the innerspring. Thus, the expandable edge-support members can also be expanded as needed expand the spacing between adjacent lateral members. Expanding the spacing between adjacent lateral members may be useful when securing the lateral members between adjacent perimeter coils that have variations in spacing therebetween within a given innerspring. Further, the expandable edge-support members may be utilized for different types of innersprings having variations in spacings between perimeter coils.

In one embodiment, an edge-support member for providing edge support is disclosed. The edge-support member may be disposed around a portion of a perimeter of an innerspring to provide edge support for the innerspring, as an example. The edge-support member includes an elongated member. The elongated member may be formed of any type of material, including but not limited to a polymer foam or a composite of polymer foam and other material, as examples. At least one expandable joint is integrally formed in the elongated member. The expandable joint can be formed by a number of different structures, including but not limited to openings, punctures, and non-planar portions disposed in the elongated member as examples. The elongated member is configured to expand in a length direction of the elongated member to allow the length of the elongated member to be expanded. In this manner, as an example, the edge-support member can be expanded as needed to be utilized to provide edge support around an innerspring having varying lengths comprising the innerspring perimeter. Further, the expandable edge-support members can be utilized for different innersprings having varying lengths comprising the innersprings' perimeters.

In another embodiment, a plurality of lateral members may be disposed in the edge-support member. The lateral members are configured to be disposed between adjacent perimeter coils of an innerspring to support attachment of the expandable edge-support member to the perimeter of the innerspring. At least one expandable joint is disposed in the elongated member between adjacent lateral members among the plurality of lateral members disposed in the elongated member. When the edge-support member is expanded, the distance between the adjacent lateral members having the expandable joint disposed therebetween also expands. In this manner, as an example, the distance between adjacent lateral members of the edge-support member can be adjusted to fit between adjacent perimeter coils of an innerspring. The distances between adjacent perimeter coils of an innerspring can vary within the same innerspring and can also vary among different innersprings.

In another embodiment, a method of constructing an edge-support member is provided. The method includes providing an elongated member. The method also includes integrally forming at least one expandable joint in the elongated member. Different methods of integrally forming the at least one expandable joint in the elongated member can be provided. As examples, at least one expandable joint may be integrally formed in the elongated member by extrusion, cutting, puncturing, and deformation processes. The at least one expandable joint is configured to expand in a length direction of the elongated member to allow the length of the elongated member to be expanded. A plurality of lateral members can also be disposed in the elongated member.

Additional features and advantages will be set forth in the detailed description which follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is an exemplary prior art mattress employing an innerspring of wire coils;

FIG. 2A is a perspective view of perimeter coils of an innerspring with edge-support members and corner-support members arranged to be installed around the perimeter coils to provide edge support;

FIG. 2B with the edge-support members and corner-support members in FIG. 2A installed around the perimeter coils in FIG. 2A to provide edge support;

FIG. 3A is a perspective view of exemplary expandable edge-support members having exemplary lateral members disposed therein, and having exemplary openings disposed between the lateral members to form exemplary expandable, integrated joints between the lateral members to allow the expandable edge-support members to be expanded lengthwise and the position of the lateral members to be adjusted with respect to each other as a result, according to one embodiment;

FIG. 3B includes front and rear views, respectively, of the expandable edge-support members of FIG. 3A;

FIG. 4A is a perspective view of perimeter coils of an innerspring and the expandable edge-support members of FIGS. 3A and 3B installed on side and corner portions of the innerspring, according to another embodiment;

FIG. 4B is a perspective view of the expandable edge-support members of FIGS. 3A and 3B installed around the entire perimeter of the innerspring in FIG. 4A;

FIG. 5A is a perspective view of another embodiment of perimeter coils of an innerspring and exemplary expandable edge-support members without lateral members and having openings disposed therein similar to the openings disposed in the expandable edge-support members of FIGS. 3A and 3B to form exemplary expandable, integrated joints in the expandable edge-support members to allow the expandable edge-support members to be expanded lengthwise;

FIG. 5B is a perspective view of the expandable edge-support members of FIG. 5A with the expandable edge-support members installed around an entire innerspring perimeter;

FIG. 6A is a perspective view of another embodiment of perimeter coils of an innerspring and exemplary expandable edge-support members having exemplary lateral members disposed therein, and having exemplary openings of varying widths disposed between the lateral members to form varying width exemplary expandable, integrated joints between the lateral members to allow the expandable edge-support members to be expanded lengthwise and the position of the lateral members to be adjusted with respect to each other as a result;

FIG. 6B is a perspective view of the expandable edge-support members of FIG. 6A installed around the entire perimeter of the innerspring in FIG. 6A;

FIG. 7A is a perspective view of another embodiment of exemplary expandable edge-support members having exemplary lateral members disposed therein, and having exemplary punctures disposed between the lateral members to form exemplary expandable, integrated joints between the lateral members to allow the expandable edge-support members to be expanded lengthwise and the position of the lateral members to be adjusted with respect to each other as a result, wherein the expandable edge-support members are not expanded;

FIG. 7B is a perspective view of the expandable edge-support members of FIG. 7A with the expandable edge-support members expanded along the length of the expandable edge-support members;

FIG. 8A is a perspective view of another embodiment of perimeter coils of an innerspring and exemplary expandable edge-support members having exemplary lateral members disposed therein, and having exemplary non-planar portions disposed between the lateral members to form exemplary expandable, integrated joints between the lateral members to allow the expandable edge-support members to be expanded lengthwise and the position of the lateral members to be adjusted with respect to each other as a result;

FIG. 8B is a perspective view of the expandable edge-support members of FIG. 8A installed around the entire perimeter of the innerspring in FIG. 8A;

FIG. 9A is a perspective view of another embodiment of exemplary expandable edge-support members having exemplary lateral members disposed therein and having exemplary non-planar portions disposed between the lateral members to form exemplary expandable, integrated joints between the lateral members to allow the expandable edge-support members to be expanded lengthwise and the position of the lateral members to be adjusted with respect to each other as a result, wherein the expandable edge-support members are not expanded;

FIG. 9B is a perspective view of the expandable edge-support members of FIG. 9A with the expandable edge-support members expanded along the length of the expandable edge-support members;

FIG. 10A is a perspective view of another embodiment of exemplary expandable edge-support members having exemplary lateral members disposed therein and having exemplary non-planar portions comprised of expandable enclosures disposed between the lateral members to form exemplary expandable, integrated joints between the lateral members to allow the expandable edge-support members to be expanded lengthwise and the position of the lateral members to be adjusted with respect to each other as a result, wherein the expandable edge-support members are not expanded;

FIG. 10B is a perspective view of the expandable edge-support members of FIG. 10A with the expandable edge-support members expanded along the length of the expandable edge-support members; and

FIGS. 11A and 11B are perspective views of the expandable edge-support members of FIGS. 10A and 10B, respectively, with a material disposed in the expandable enclosure.

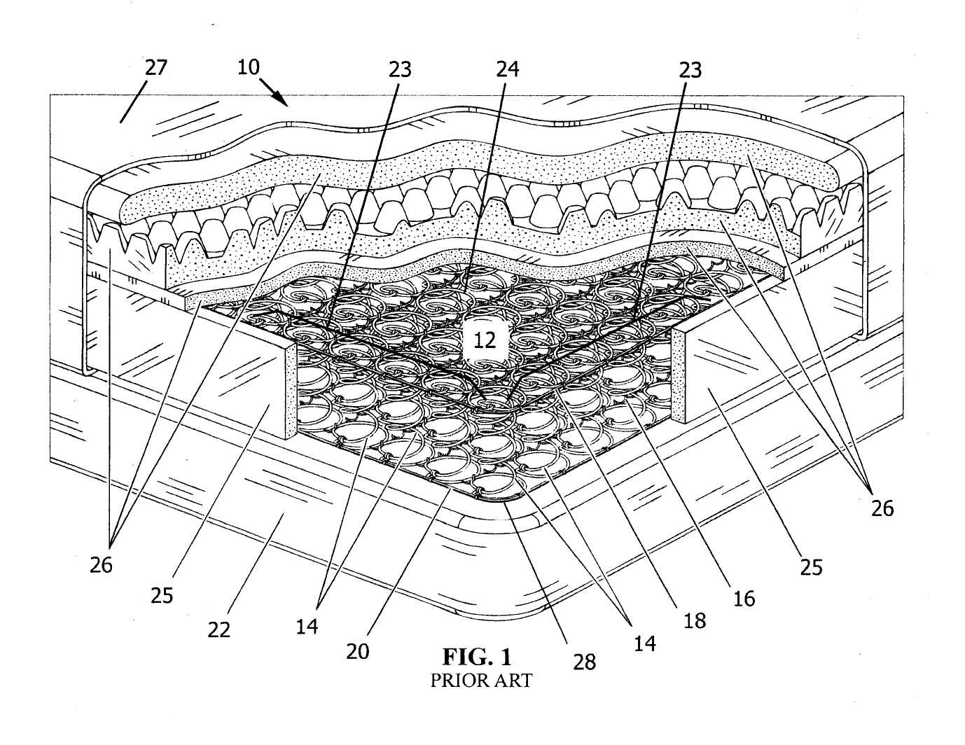

### DETAILED DESCRIPTION

Embodiments in the detailed description include expandable edge-support members, assemblies, and related methods. The expandable edge-support members can be used to provide edge support, including side support and corner support, for an innerspring. The expandable edge-support members, assemblies, and related methods are suitable for bedding and seating applications as examples. The expandable edge-support members are expandable in length. By being expandable in length, the expandable edge-support members can be expanded as needed to be utilized to provide edge support for an innerspring having variations in perimeter lengths. Further, the expandable edge-support members may be utilized for different types of innersprings having variations in perimeter lengths between the different types of innersprings. Further, the expandable edge-support members may include a plurality of lateral members that are configured to be disposed between adjacent perimeter coils of an innerspring to support attachment of the expandable edge-support members to the innerspring. Thus, the expandable edge-support members can also be expanded as needed expand the spacing between adjacent lateral members. Expanding the spacing between adjacent lateral members may be useful when securing the lateral members between adjacent perimeter coils that have variations in spacing therebetween within a given innerspring. Further, the expandable edge-support members may be utilized for different types of innersprings having variations in spacings between perimeter coils.

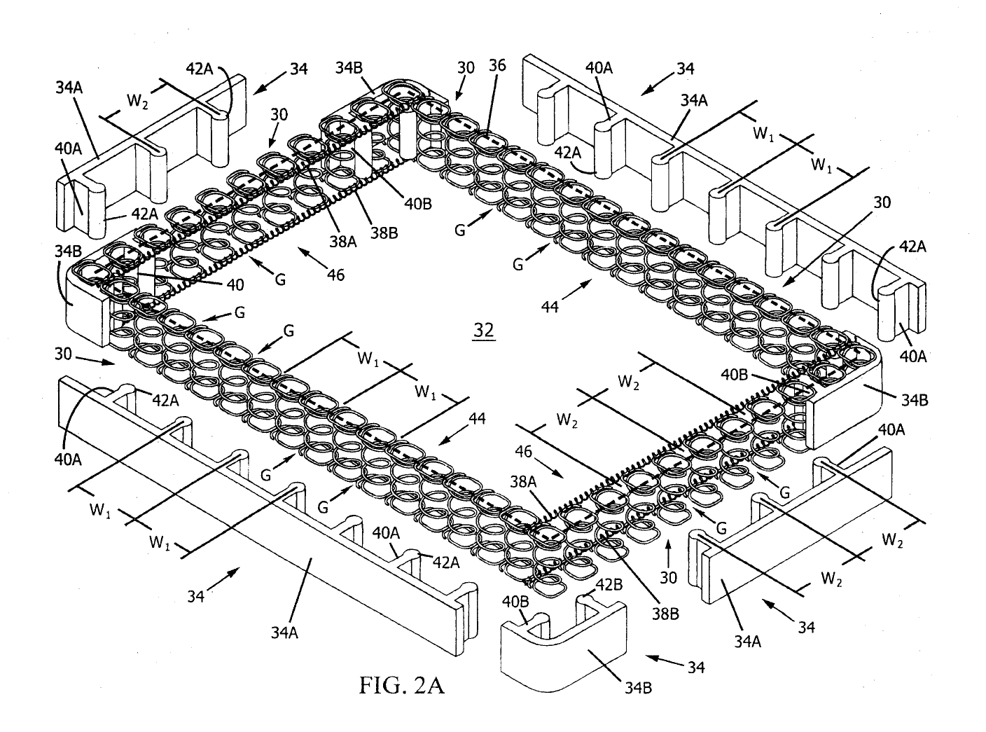

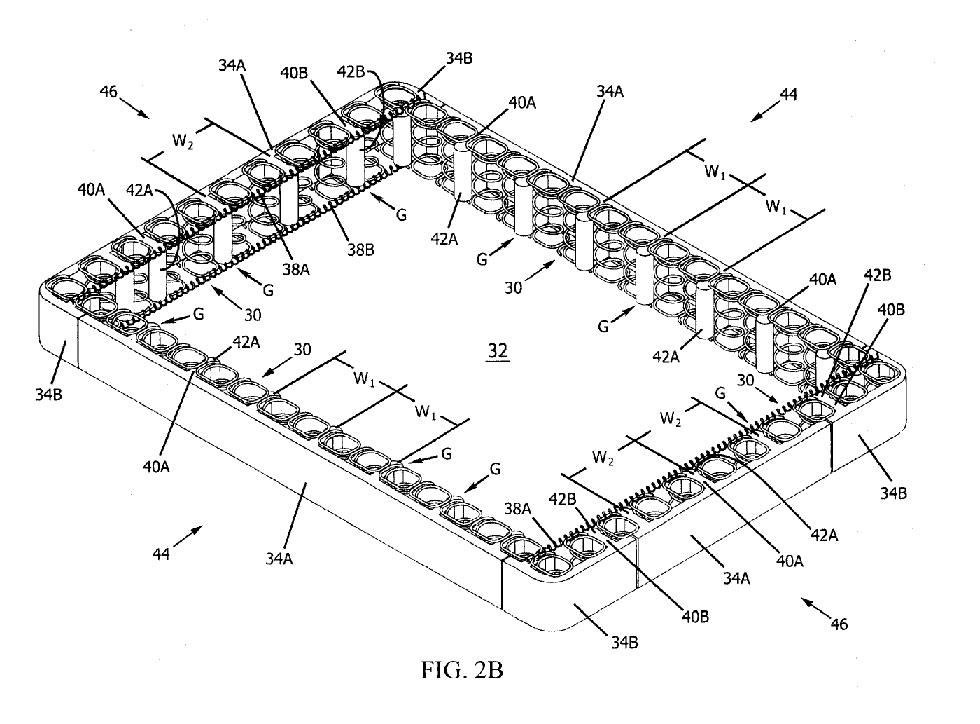

FIG. 2A is a perspective view of exemplary perimeter coils 30 of an innerspring assembly 32 with edge-support members 34. FIG. 2B is a perspective view of the perimeter coils 30 of FIG. 2A with the edge-support members 34 of FIG. 2A installed around the perimeter coils 30 to provide edge support for the innerspring assembly 32. As illustrated therein, the perimeter coils 30 are aligned next to each other around a perimeter 36 of the innerspring assembly 32. The perimeter coils 30 are typically disposed adjacent to interior coils (not shown) disposed inside the perimeter 36 of the innerspring assembly 32. The perimeter coils 30 and interior coils disposed in the innerspring assembly 32 form a sleep surface area. In this embodiment, the perimeter coils 30 are unpocketed coils bonded together by a top border wire 38A and a bottom border wire 38. However, the top and bottom border wires 38A, 38B may be eliminated, if desired. For example, the perimeter coils 30 could be provided as pocketed coils.

The edge-support members 34 are formed from a material that is allowed to compress and expand as force is placed on the perimeter 36 of the innerspring assembly 32. In this manner, the edge-support members 34 provide edge support for the innerspring assembly 32. The edge-support members 34 may exhibit a degree firmness that is same or different than the degree of firmness of the perimeter coils 30. For example, the firmness of the edge-support member 34 may be more firm than the firmness of the perimeter coils 30. Thus, as a load moves from the perimeter coils 30 to the edge-support members 34, the load will experience a higher degree of firmness on the edge-support members 34. Such an arrangement may make it acceptable to users to have an innerspring assembly 32 containing a greater amount or area of polymer edge support that intrudes into a greater portion of the sleeping area.

When the perimeter coils 30 are disposed adjacent to each other around the perimeter 36 of the innerspring assembly 32, a natural gap G is formed between the adjacent perimeter coils 30 as illustrated in FIG. 2A. This is because the perimeter coils 30 are circular-shaped in this embodiment. These gaps G provided between adjacent perimeter coils 30 provide for the ability of lateral members 40A, 40B disposed in the edge-support members 34 to be disposed in the gaps G when the edge-support members 40 are disposed around the perimeter 36 of the innerspring assembly 32 to provide edge-support. This is shown in FIG. 2A wherein some of the corner edge-support members 34B have their lateral members 40B disposed in gaps G formed between adjacent perimeter coils 30. Further, this is illustrated in FIG. 2B, wherein the lateral members 40A, 40B of both the side edge-support members 34A and corner edge-support members 34B, respectively, are disposed in gaps G formed between adjacent perimeter coils 30.

The lateral members 40A, 40B, by being disposed in the gaps G formed between the perimeter coils 30, provide one technique for securing the attachment of the edge-support members 34 to the perimeter coils 30. When a force is applied to the edge-support members 34 and the perimeter coils 30, the lateral members 40A, 40B assist to maintain attachment of the edge-support members 34 with the perimeter coils 30 and thus the innerspring assembly 32. Further, the lateral members 40A, 40B may further include end portions 42 that are wider when uncompressed than the width of the gaps G such that the edge-support members 34 will then to stay secured to the perimeter coils 30 as lateral forces or lateral components of forces are applied to the edge-support members 34. Additional attachment means, including adhesives, epoxies or mechanical fasteners, may also be employed to secure the edge-support members 34 to the perimeter coils 30.

Due to variations in coil types and sizes that may be employed in the innerspring assembly 32, the widths between adjacent perimeter coils 30 may vary around the perimeter 36 of the innerspring assembly 32. Further, if the perimeter coils 30 have different lengths in width and depth directions, changing the orientation of the perimeter coils 30 on different sides of the perimeter 36 can change the widths between adjacent perimeter coils 30. For example, the widths between adjacent perimeter coils 30 on longer sides 44 of the innerspring assembly 32 are of width W₁, whereas the widths between adjacent perimeter coils 30 on shorter sides 46 of the innerspring assembly 32 are of width W₂, as illustrated in FIG. 2A. Because the spacing between the perimeter coils 30 may vary, the spacing between adjacent gaps G also varies as a result, as also illustrated in FIG. 2A. In this regard, as illustrated in FIG. 2A, the distance between the lateral members 40A disposed in the side-support members 34A are also varied as width W₁ and width W₂ so that the lateral members 40A will properly align with the gaps G formed between adjacent perimeter coils 30 to assist in securing the edge-support members 34 to the perimeter coils 30.

Thus, in this example, two different types of side-support members 34A are provided so that their respective lateral members 40A will properly align with the spacings between the gaps G formed between adjacent perimeter coils 30. If the spacings between the gaps G vary in more than two (2) unique manners, further edge-support members 34 having the same unique spacings between the lateral members 40A, 40B would need to be provided. Thus, more than one (1) type of edge-support member 34 must be provided for the innerspring assembly 32 if the spacings between the gaps G vary, thereby requiring manufacturing and stocking of different types of edge-support members 34. This leads to additional manufacturing and stocking of additional models, thereby decreasing flexibility. Further, different types of innerspring assemblies may have different gap spacings between them due to variations in coil types employed, perimeter lengths, and other variations. Thus, additional models of edge-support members 34 would need to be provided to accommodate these variations among different innerspring assemblies. Thus, the number of edge-support member types or variations required to be produced and stocked by a manufacturer or user of edge-support members could be as many as the maximum number of unique gap spacings between perimeter coils in a given innerspring assembly multiplied by the number of different types of innerspring assemblies.

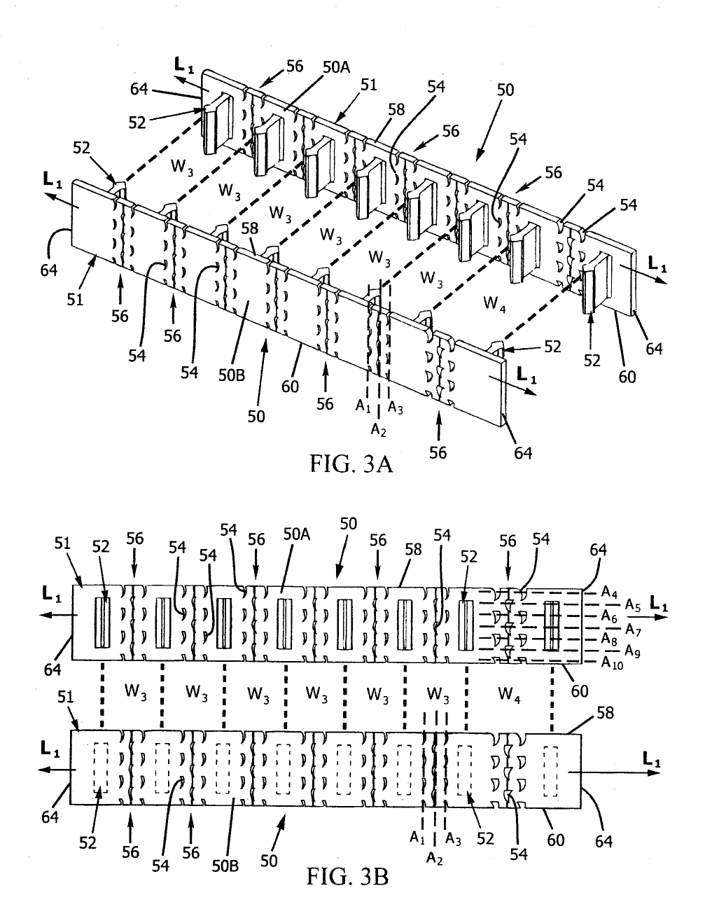

In this regard, embodiments disclosed herein and illustrated in FIGS. 3A-11B, described below, include expandable edge-support members, assemblies, and related methods that can be used to provide edge support, including side support and corner support, for an innerspring. The expandable edge-support members are expandable in length. By being expandable in length, the expandable edge-support members can be expanded as needed to be utilized to provide edge support for an innerspring having variations in perimeter lengths. Thus, the number of edge-support member types or variations required to be produced and stocked by a manufacturer or user of edge-support members can be reduced to support variations in perimeter lengths between the different types of innersprings, as an example. Further, the expandable edge-support members may include a plurality of lateral members that are configured to be disposed between adjacent perimeter coils of an innerspring to support attachment of the expandable edge-support members to the innerspring.

In this regard, FIG. 3A is a perspective view of exemplary expandable edge-support members 50. The exemplary expandable edge-support members 50 are comprised of elongated members 51 in this embodiment. The elongated members 51 have exemplary lateral members 52 disposed therein. FIG. 3B includes front and rear views, respectively, of the expandable edge-support members 50 of FIG. 3A. In FIGS. 3A and 3B, two expandable side-support members 50A, 50B are shown, wherein each are disposed parallel and across from each other, but each expandable edge-support member 50A, 50B is the same configuration in this embodiment. The lateral members 52 are configured to be disposed between coils disposed in an innerspring to provide attachment support between the expandable edge-support members 50 and an innerspring, as previously discussed above.

Further in this embodiment of FIGS. 3A and 3B, the elongated members 51 have openings 54 integrally formed in the elongated members 51 between the lateral members 52 to form expandable, integrated joints 56 in the expandable edge-support members 50. As examples, the openings 54 could be formed in the elongated members 51 using an extrusion process or cutting process, such as die cutting for example. By being expandable, the expandable, integrated joints 56 allow the elongated members 51 to be expanded in a length direction L₁ of the elongated members 51, as illustrated in FIGS. 3A and 3B. Thus, the expandable edge-support members 50 can be expanded lengthwise as needed to be utilized to provide edge support, including for an innerspring. Further, because the expandable, integrated joints 56 are disposed between adjacent lateral members 52 in this embodiment, expansion of the expandable, integrated joints 56 in the elongated members 51 also expands the distance or spacing W₃ between lateral members 52. In the example of FIGS. 3A and 3B, one of the expandable, integrated joints 56 is expanded to provide a distance or spacing W₄ between lateral members 52, wherein W₄ is greater than W₃. The spacing W₄ is formed by a force being placed on the openings 54 to expand the openings 54 thus expanding the length of the elongated member 51. Thus, the distance or spacing W₃ can be adjusted to align with variations in gap spacings between perimeters coils when the lateral members 52 are disposed between perimeter coils to secure the expandable edge-support members 50 to an innerspring as an example.

Further in this embodiment, a plurality of openings 54 are integrally formed in the elongated members 51 to form each expandable, integrated joint 56. Some of the openings 54 are disposed on a top edge 58 and a bottom edge 60 of the elongated members 51. This allows the top edge 58 and the bottom edge 60 of the expandable edge-support members 50 to be expanded lengthwise in direction L₁, as illustrated in FIGS. 3A and 3B. Further in this embodiment, the openings 54 are disposed in three (3) vertical axes A₁, A₂, and A₃, as illustrated in FIGS. 3A and 3B, although there is no restriction on the number of vertical axes that may be employed. The openings 54 are disposed along each of the vertical axes A₁, A₂, and A₃ in this embodiment. Thus, when the expandable, integrated joint 56 is expanded in the elongated member 51, the elongated member 51 expands in length wherein the openings 54 expand out from each other about the vertical axes A₁, A₂, and A_{3.}

Further in this embodiment, the openings 54 are disposed in the vertical axes A₁, A₂, and A₃ such that a portion of one of the openings 54 is disposed along each length axis (e.g., length axis A₄, A₅, A_{6,} A₇, A₈, A_{9,} and A₁₀) of the elongated member 51. Thus, entire end faces 64 of the elongated members 51 are allowed to be expanded in a planar manner when a pulling force is placed on the elongated members 51 to expand one or more of the expandable, integrated joints 56. Thus, the entire vertical cross-section of the elongated members 51 can be expanded equally to allow for the expandable edge-support members 50 to be expanded and disposed around different lengths of perimeters to provide edge support, including around the perimeter of an innerspring.

The expandable edge-support members 50 may be formed from any material desired, which may or may not be foamed. These material examples include, but are not limited to, a polymer, a polymer foam, latex, a viscoelastic, and a viscoelastic foam, as examples. Further, the expandable edge-support members 50 may be formed from one or more materials selected from the group consisting of polystyrenes, polyolefins, polyethylenes, polybutanes, polybutylenes, polyurethanes, polyesters, ethylene acrylic copolymers, ethylene-vinyl-acetate copolymers, ethylene-methyl acrylate copolymers, ethylene-butyl-acrylate copolymers, ionomers, polypropylenes, copolymers of polypropylene, and the like, as examples. Further, the expandable edge-support members 50 may be formed from a combination of thermoset and thermoplastic material(s), either one foamed or not, to provide cushioning characteristics of both resiliency and structural support. Further, the expandable edge-support members 50 may exhibit any degree of firmness desired.

Examples of thermoplastics have been previously discussed above. One example of a thermoset material is latex foam rubber, which is one example of a thermoset elastomer. Latex rubber exhibits recovery and lack of compressive set characteristics while maintaining the tactile cushioning. It is a natural material and is considered biodegradable. Latex is hypo-allergenic, and breathes to keep you warm in the winter and cool in the summer. Further, bacteria, mildew, and mold cannot live in latex foam. It is generally obtained in emulsified form and is frothed to introduce air into the emulsion to reduce density and is then cured (vulcanized) to remove additional waters and volatiles as well as to set the material to its final configuration. Used in combination with a thermoset, thermoplastic foams can consume space within a cushion structure, thereby displacing the heavier-weight, more expensive latex rubber foam component. The thermoset foam component can also be further cost-reduced through the addition of fillers such as ground foam reclaim materials, nano clays, carbon nano tubes, calcium carbonate, flyash and the like, but also corc dust as this material can provide for increased stability to reduce the overall density and weight of the thermoset material.

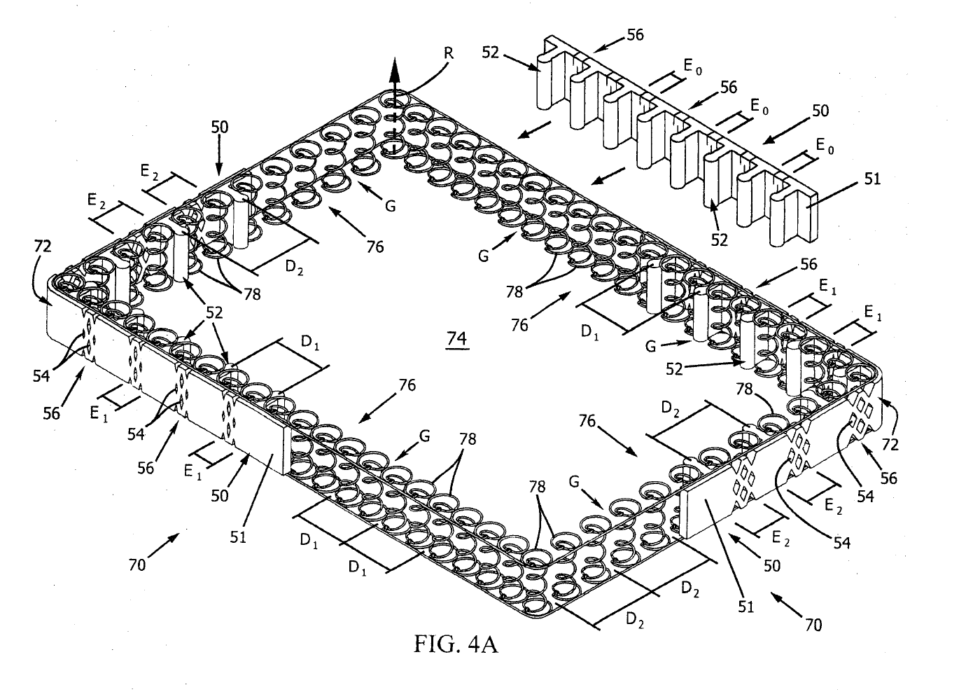

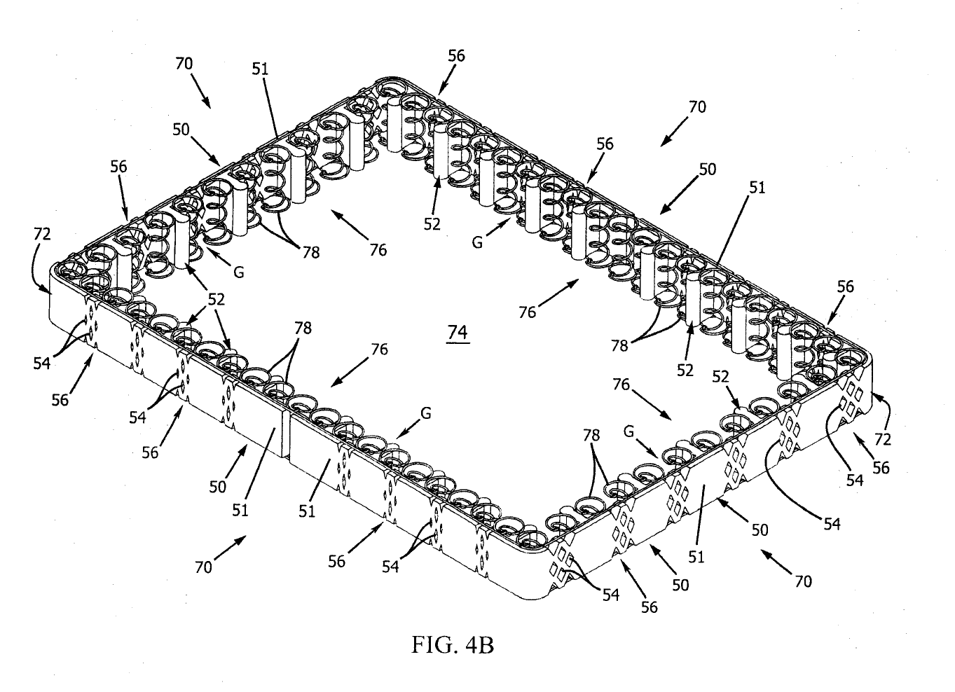

FIG. 4A is a perspective view of how the expandable edge-support members 50 of FIGS. 3A and 3B can be expanded to be installed on sides 70 and corner portions 72 of an exemplary innerspring 74 as an example. FIG. 4B is a perspective view of the expandable edge-support members 50 of FIGS. 3A and 3B installed around the entire perimeter of the innerspring 74. The sides 70 and corner portions 72 of the innerspring 74 may be of any length and radius, respectively, desired. When it is desired to install the expandable edge-support members 50 around the sides 70 and/or corner portions 72 of the innerspring 74, the expandable edge-support members 50 will be in an unexpanded state wherein the openings 54 in the expandable, integrated joints 56 are not expanded. For example, the width between the expandable, integrated joints 56 in an unexpanded form may be width E₀, as illustrated in FIG. 4A. Once the expandable edge-support members 50 are installed on a perimeter 76, the expandable, integrated joints 56 disposed therein can be expanded as needed such that the lateral members 52 can be disposed between adjacent perimeter coils 78 in the innerspring 74 having various or variable gap distances therebetween.

For example, as illustrated in FIG. 4A, the distance between the gaps G between the perimeter coils 78 in the innerspring 74 can vary, for example, widths D₁ and D₂. The variation may be between perimeter coils 78 on the same side 70 of the innerspring 74 and/or between different sides 70 of the innerspring 74. Thus, by the expandable edge-support member 50 being expandable via the expandable, integrated joints 56, the spacing or width between adjacent lateral members 52 can be matched to widths D₁ and D₂, respectively, if desired. For example, the spacing or width between lateral members 52 are expanded via expanding of the expandable, integrated joints 56 to E₁ and E₂ to match the widths D₁ and D₂ between the gaps G between the perimeter coils 78. In this manner, the expandable edge-support members 50 can be expanded to be adjusted to fit varying sizes of innersprings 74 and variations in sizes and lengths of sides 70 as well as variations in widths between gaps G formed between the perimeter coils 78. The expandable, integrated joints 56 also allow the expandable edge-support members 50 to be extended around the corner portions 72 have varying radii R, as illustrated in FIG. 4A. The radius R of the corner portions 72 affect the length that the elongated member 51 must extend around the corner portions 72. Thus, if the length of the elongated member 51 needs to be extended to properly extend around the corner portions 72, an expandable, integrated joint 56, located adjacent to the corner portion 72, can be extended to extend the length of the elongated member 51.

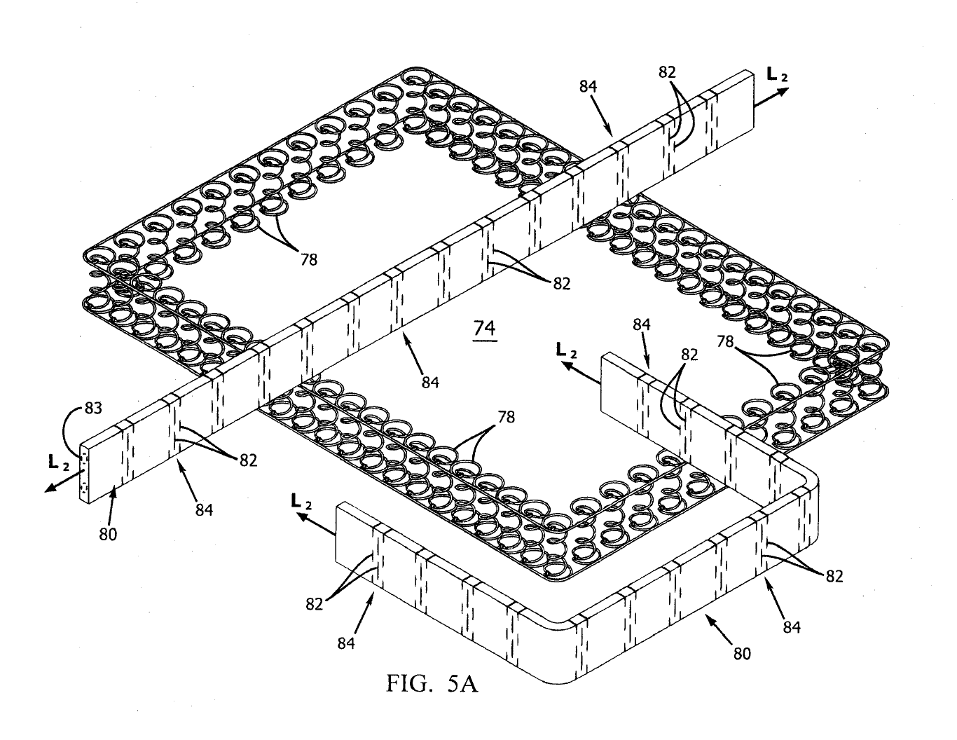

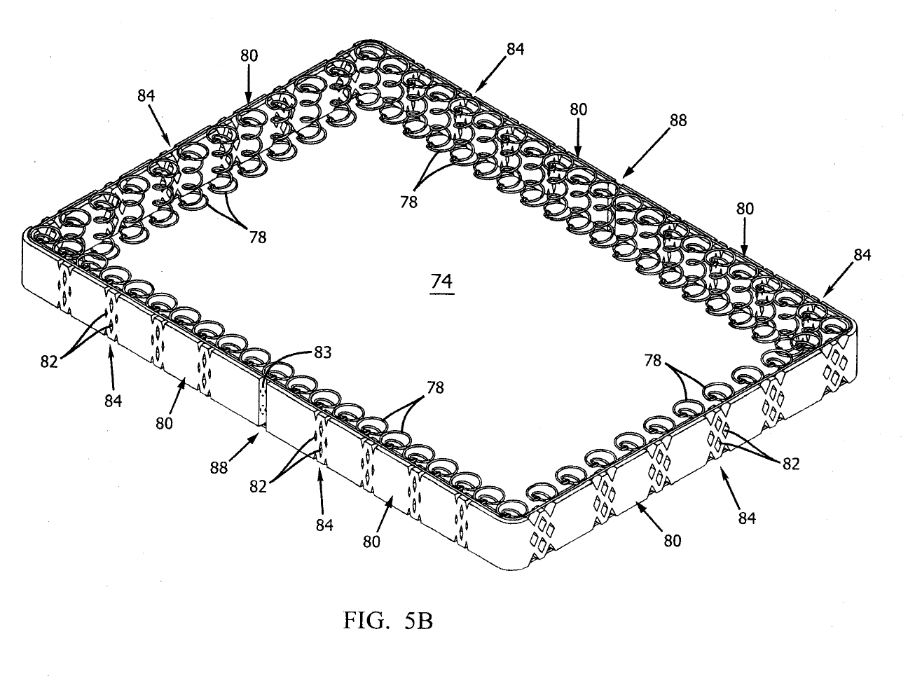

The expandable edge-support member 50 in FIGS. 3A-4B that includes the one or more expandable, integrated joints 56 does not have to include the lateral members 52. In this regard, FIGS. 5A and 5B illustrate an example of expandable edge-support members 80 that do not include lateral members. FIG. 5A is a perspective view of the exemplary edge-support members 80 without lateral members and having openings 82 disposed therein similar to the openings 54 disposed in the expandable edge-support members 50 of FIGS. 3A-4B to form exemplary expandable, integrated joints 84 in the expandable edge-support members 80 to allow the expandable edge-support members 80 to be expanded in a length direction L₂ of the expandable edge-support members 80. As an alternative example, edge-support members 80 may also include at least one or more longitudinal channels 83 disposed through the edge-support members 80 providing both cost savings methods through material reduction and customizable cushioning attributes.

In this embodiment, the expandable, integrated joints 84 are similar to the expandable, integrated joints 56 of FIGS. 3A-4B and thus the previous description of the expandable, integrated joints 56 is applicable for the expandable, integrated joints 84 and will not be described again. Also, the innerspring 74 provided in FIGS. 5A and 5B is the same innerspring 74 as provided in FIGS. 4A and 4B and thus will also not be described again. The expandable edge-support members 80 can be disposed around the entire perimeter of the innerspring 74 adjacent to the perimeter coils 78, as illustrated in FIG. 5B. The expandable edge-support members 80 can be secured to the perimeter coils 78 in any manner desired. In the example of FIG. 5B, the entire perimeter of the innerspring 74 is surrounded by two (2) expandable edge-support members 80, which may then be jointed together at junctions 88 to be secured as one (1) unitary edge-support around the innerspring 74.

Each of the expandable, integrated joints 56, 84 contains openings 54, 82 that are of the same size and spacing such that the expandable, integrated joints 56, 84 have the same widths when they are in an unexpanded state. However, variations can be introduced between expandable, integrated joints in expandable edge-support members disclosed herein such that the expandable, integrated joints 84 have different widths. Providing expandable, integrated joints in an expandable edge-support member may assist in securing the expandable edge-support member to a perimeter of an innerspring that may contain different gap variations between perimeter coils along sides of the innerspring and in corner portions.

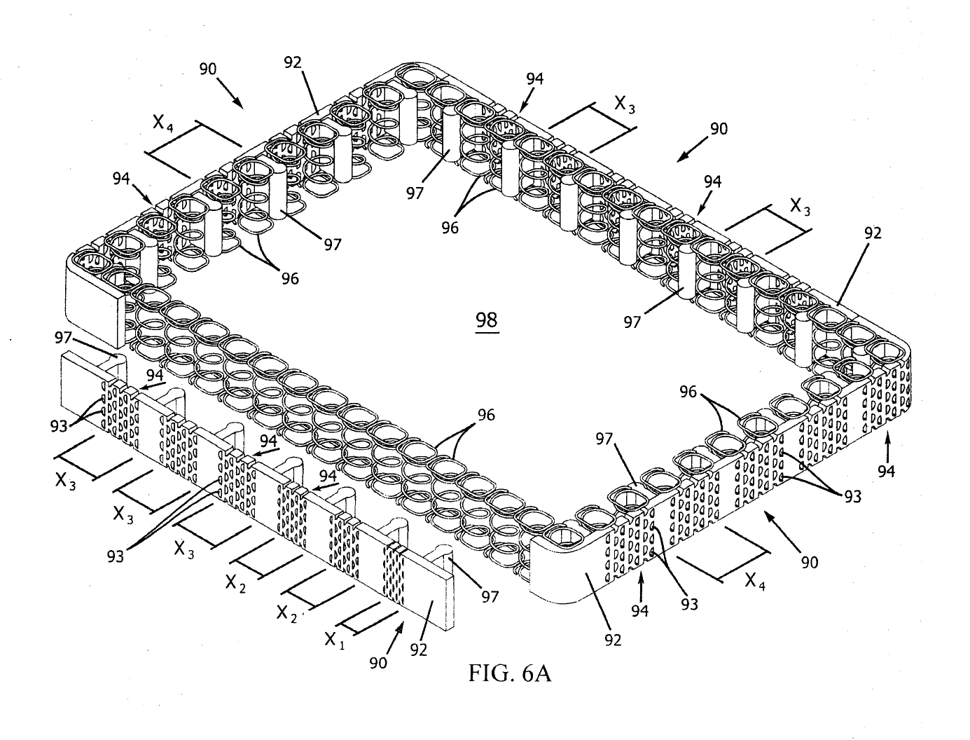

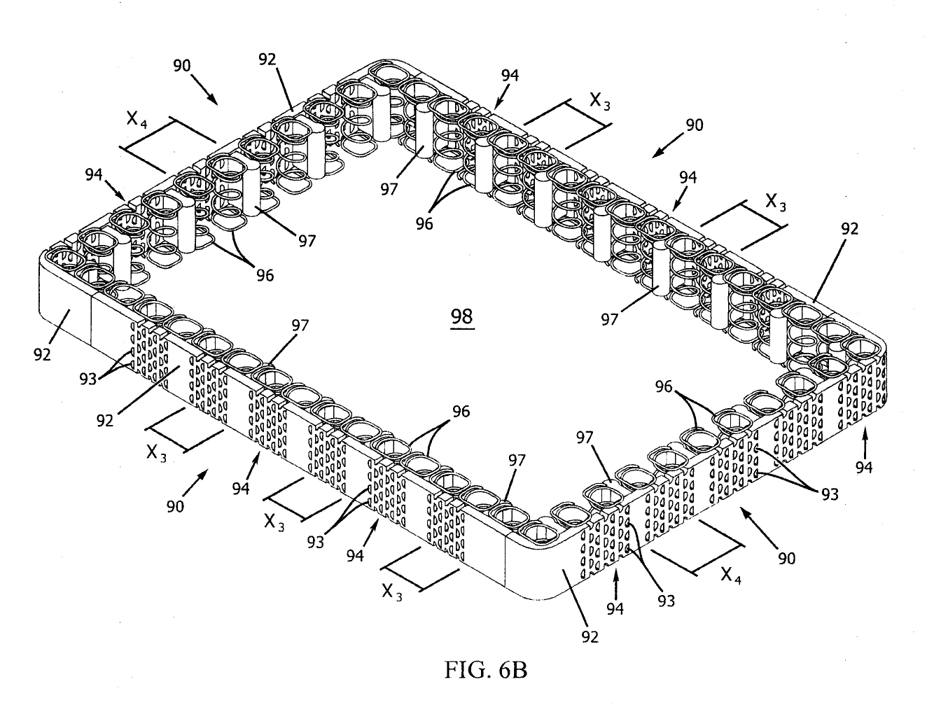

In this regard, FIGS. 6A and 6B illustrate an example of another alternative expandable edge-support member 90 that is comprised of elongated members 92 and each contain a plurality of expandable, integrated joints 94 disposed therein. FIG. 6A is a perspective view of another embodiment of perimeter coils 96 of an innerspring 98 and the expandable edge-support members 90. FIG. 6B is a perspective view of the expandable edge-support members 90 of FIG. 6A installed around the entire perimeter of the innerspring 98. As illustrated in FIG. 6A, the expandable, integrated joints 94 disposed in the expandable edge-support member 90 have varying widths X₁, X₂, and X₃ disposed between lateral members 97 disposed in the expandable edge-support members 90. The varying widths are controlled by a pulling force placed on the openings 93 disposed in the expandable, integrated joints 94. For example, the size of the openings 93 of the expandable, integrated joints 94 are in an unexpanded state vary to produce expandable, integrated joints 94 having varying widths X₁, X₂, and X₃, as illustrated in FIG. 6A. The expandable, integrated joints 94 can be expanded to any widths desired that are capable being provided by the expandable, integrated joints 94, for example width X_{4,} as illustrated in FIG. 6A. Further, the width of the expandable, integrated joints 94 could be retained when the expandable edge-support member 90 is installed on the innerspring 98, such as width X₃ for example, as illustrated in FIGS. 6A and 6B.

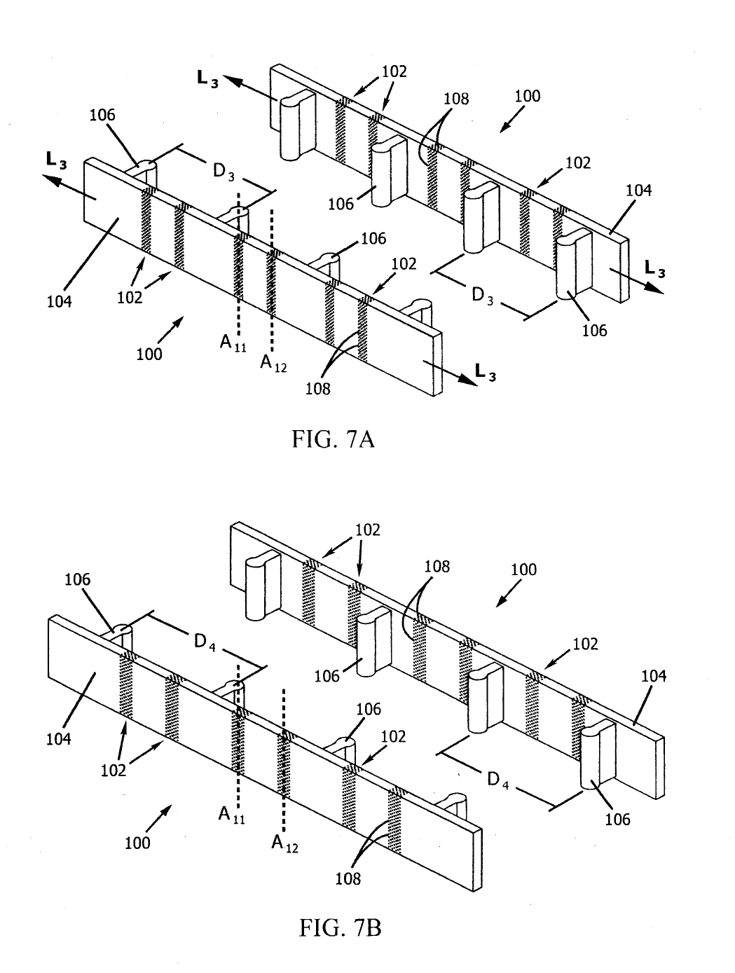

Expandable, integrated joints can be formed in an elongated member of an expandable edge-support member in other manners other than disposing openings in the elongated member. In this regard, FIGS. 7A and 7B illustrate another embodiment of expandable edge-support members 100 that include expandable, integrated joints 102 disposed therein that are formed from providing punctures. FIG. 7A is a perspective view of the expandable edge-support members 100 in an unexpanded form. FIG. 7B illustrates the expandable edge-support members 100 in an expanded form. In this embodiment, the expandable edge-support members 100 are comprised of an elongated member 104 that may be constructed out of any material desired, examples of which have been previously described. Lateral members 106 are disposed in the elongated members 104. Punctures 108 are integrally disposed along vertical axes A₁₁, A₁₂ through the elongated members 104 in this embodiment. The punctures 108 serve to form the expandable, integrated joints 102 to allow the elongated members 104 to expand in a length direction L₃. In turn, because the expandable, integrated joints 102 are disposed between the lateral members 106 disposed in the elongated members 104, expansion of the expandable, integrated joints 102 allows the spacing or width between the lateral members 106 to be expanded. For example, the spacing or width between the lateral members 106 when the expandable, integrated joint 102 is not expanded is D₃, as illustrated in FIG. 7A. However, when the expandable, integrated joint 102 is expanded, the spacing or width between the lateral members 106 is width D₄, as illustrated in FIG. 7B. More than one expandable, integrated joint 102 may be disposed between the lateral members 106 as well, as illustrated in FIGS. 7A and 7B, to allow for greater expansion in spacing between adjacent lateral members 106.

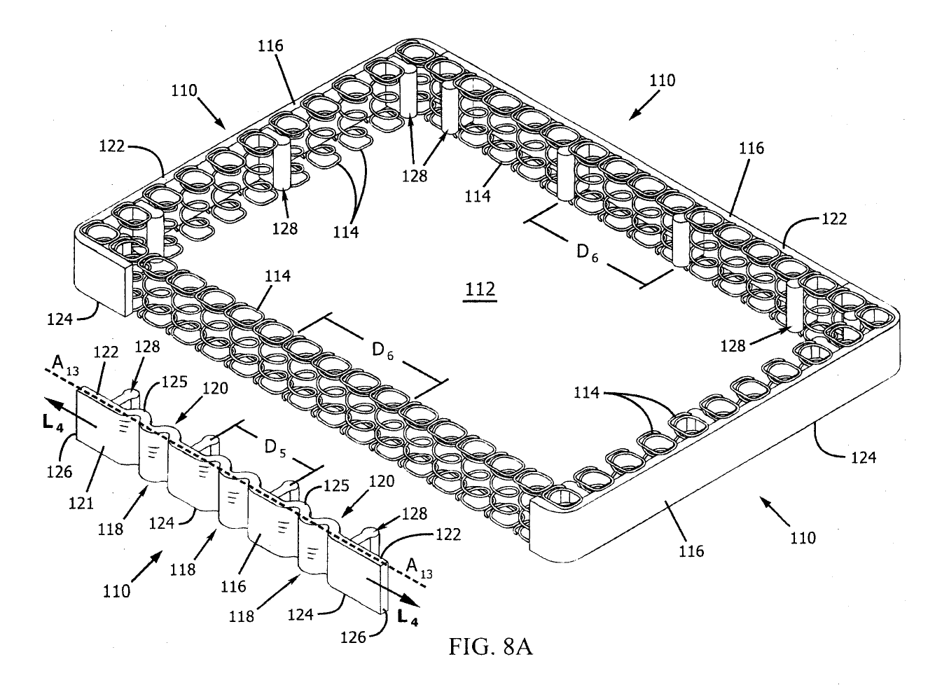

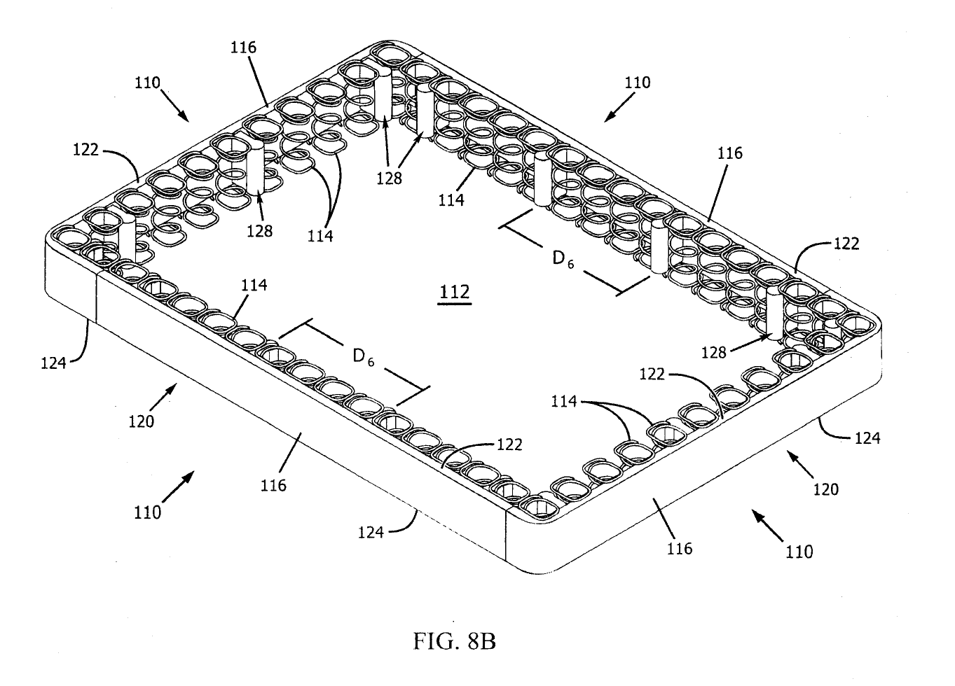

Expandable, integrated joints can also be disposed in an expandable edge-support member in methods and forms other than openings and punctures. For example, a non-planar portion can be integrally formed into an elongated member that provides edge support to form an expandable edge-support member. The non-planar portion allows the elongated member to expand in a length direction of the elongated member to provide an expandable edge-support member. In this regard, FIG. 8A is a perspective view of another embodiment of an expandable edge-support member 110 that can be used to provide edge support for an innerspring 112. FIG. 8B is a perspective view of the expandable edge-support members 110 of FIG. 8A installed around the entire perimeter of the innerspring 112 of FIG. 8A. As previously discussed, the expandable edge-support member 110 can be disposed around the perimeter of the innerspring 112 adjacent to perimeter coils 114. The expandable edge-support member 110 is comprised of an elongated member 116, which may be formed from any other aforementioned materials, as examples. One or more non-planar portions 118 are disposed in the elongated member 116 to form one or more expandable, integrated joints 120 in the elongated member 116 to allow the elongated member 116 to be extended along length L₄, as illustrated in FIG. 8A. Thus, the expandable edge-support member 110 can be extended to fit to the perimeter of different sizes of sides and corner portions of the innerspring 112, as desired and previously discussed.

By non-planar portion, it is meant that a disruption of some type or form is disposed in the planarity of sides 121 of the elongated members 116 such that the non-planar portion is non-planar with a longitudinal axis of the elongated members 116. For example, as illustrated in FIG. 8A, the non-planar portions 118 are S-shaped portions that are disposed in the elongated members 116 that are non-planar with the longitudinal axis or plane A₁₃ of the elongated members 116. The non-planar portions 118 could also include a single or multiple inflection points in addition to S-shaped portions. The non-planar portion 118 may include rounded, straight, or other shapes of edges 125, as desired. In this embodiment, the non-planar portions 118 are disposed between a top edge 122 and a bottom edge 124 of the elongated member 116 so that the expansion of the elongated member 116 via expansion of the non-planar portion 118 extends the length of an entire end face 126 of the elongated member 116.

The elongated members 116 may not have included non-planar portions when first manufactured or formed, and the non-planar portions 118 may be disposed in the elongated members 116 thereafter. The non-planar portions 118 could also be formed in the elongated members 116 as part of a mold, die or other tooling to form the elongated members 116 in the first instance. Also, the non-planar portions 118 could have been formed in the elongated members 116 by a cutting process after the elongated members 116 were initially formed. Any method to form the non-planar portions 118 into the elongated members 116 desired can be employed and is encompassed herein.

Further in this embodiment, similar to previous embodiments described above, lateral members 128 are disposed in the elongated member 116 to facilitate securing of the expandable edge-support member 110, as previously described. For example, as illustrated in FIG. 8A, the width between adjacent lateral members 128 is D₅ when the expandable edge-support member 110 is unexpanded. However, when the expandable edge-support member 110 is expanded, such as illustrated in FIG. 8B, the width between adjacent lateral members 128 is D₆ in this example. Thus, the non-planar portions 118 forming the expandable, integrated joints 120 allow the position of the lateral members 128 to be expanded, as needed or desired.

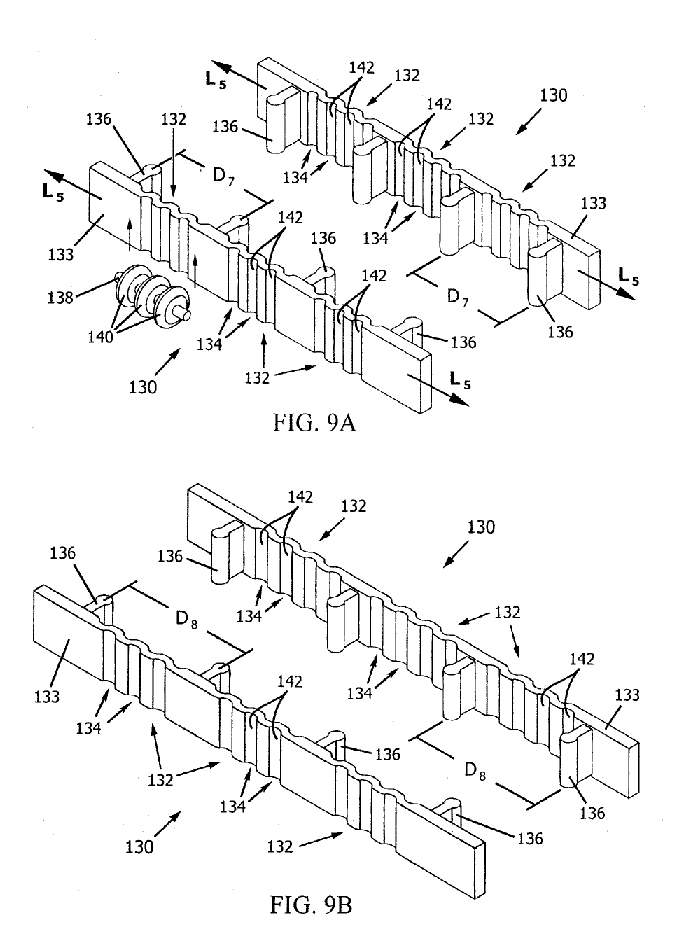

FIGS. 9A and 9B illustrate alternative embodiments of expandable edge-support members 130 that include non-planar portions 132 disposed in an elongated member 133 to form expandable, integrated joints 134 similar to the expandable edge-support members 110 in FIGS. 8A and 8B. FIG. 9A is a perspective view of the expandable edge-support members 130 wherein the non-planar portions 132 forming the expandable, integrated joints 134 are disposed between exemplary lateral members 136 disposed in the elongated member 133. The non-planar portions 132 are not expanded in FIG. 9A. Thus, the distance between adjacent lateral members 136 in this embodiment is D₇, as illustrated in FIG. 9A. FIG. 9B is a perspective view of the expandable edge-support members 130 of FIG. 9A with the non-planar portions 132 expanded to extend the length of the elongated member 133 to extend the length of the expandable edge-support member 130. When the non-planar portions 132 are expanded, the distance between adjacent lateral members 136 is D₈, as illustrated in FIG. 9B. Just as previously discussed, the lateral members 136 are configured to be disposed in spacings between adjacent coils to secure the expandable edge-support members 130 to an innerspring or other structure having perimeter coils or other spacings.

The non-planar portions 132 may be disposed in the elongated member 133 in any manner desired. Forming non-planar indentions 142 in the elongated members 133 will cause the length of the elongated members 133 to shorten due to the material of the elongated members 133 being displaced in a different plane from the longitudinal plane of the elongated members 133. As an example, as illustrated in FIG. 9A, a roller, cutter or other forming device 138 may be used to form the non-planar portion 132 into the elongated member 133. The roller, cutter or other forming device 138 in this embodiment can contain individual wheels, cutters or other forming mechanisms 140 that can traverse across the elongated member 133 on a path perpendicular to the length direction L₅ of elongated member 133 to form the non-planar portion 132 into the elongated members 133 to form the expandable edge-support member 130. The number of rollers, cutters or other forming mechanisms 140 controls the number of non-planar indentions 142 formed in the elongated members 133 to form the expandable, integrated joint 134.

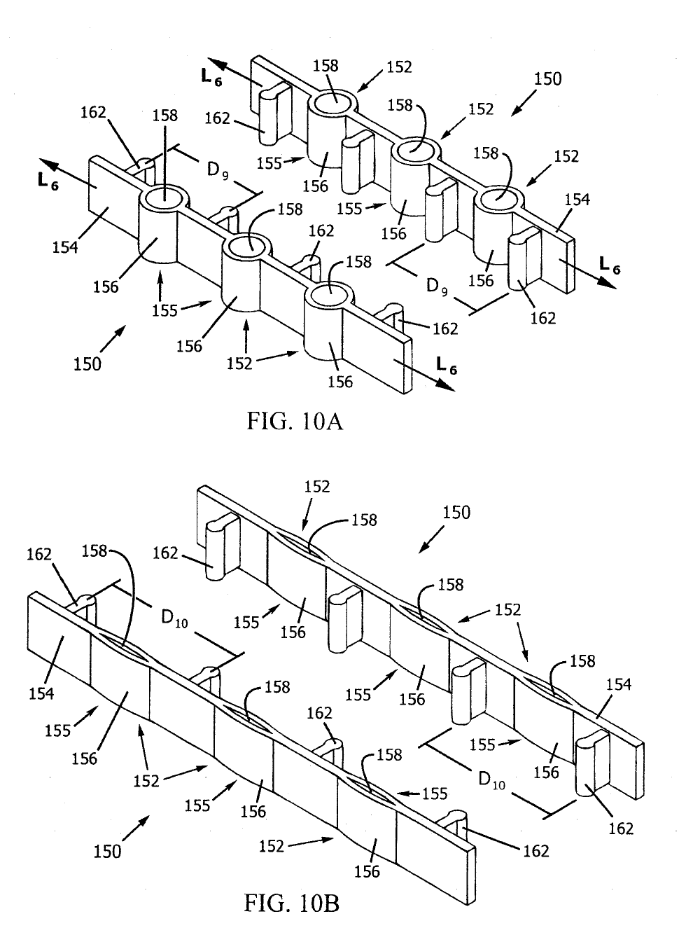

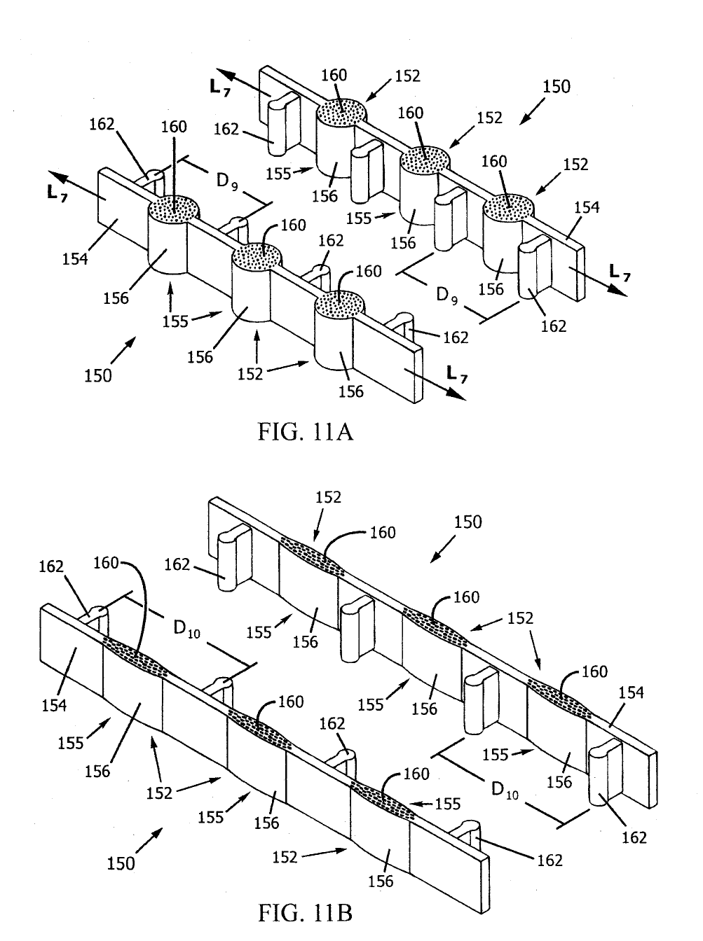

FIGS. 10A-11B are perspective views of another embodiment of exemplary expandable edge-support members 150 having non-planar portions 152 disposed in elongated members 154 to form expandable, integrated joints 155 therein, thereby allowing the elongated members 154 to be expanded lengthwise in a vertical direction L₆ (FIG. 10A) or L₇ (FIG. 11A). In this embodiment, the non-planar portions 152 can be comprised of a composite. The non-planar portions 152 in this embodiment are comprised of expandable enclosures 156 formed in the elongated members 154. The expandable enclosures 156 include an interior 158. The interior 158 can be left void of additional material, as illustrated in FIGS. 10A and 10B, or can be configured to receive another material in the interior 158, as illustrated in FIGS. 11A and 11B. For example, the elongated member 154 could be a thermoplastic material to provide support, and a thermoset could therein be deposited in the interiors 158 of the expandable enclosures 156 as a composite material 160, as illustrated in FIGS. 11A and 11B.

As an alternative example, the expandable enclosures 156 could be comprised entirely of a material dissimilar to that of the elongated member 154. In this manner, the edge support members 150 could have elongated members 154 and lateral members 162 comprised of a first material and the non-planar portions 152 comprised of a second composite material 160 to form expandable, integrated joints 155, as illustrated in FIGS. 11A and 11B. Examples of thermoplastic and thermoset materials have been previously discussed and are applicable here as well. Thus, the non-planar portions 152 are comprised of a composite in this example. Any other material choices are possible. In this example, the composite material 160 may be a compressible material that exhibits resiliency characteristics that bias the expandable enclosures 156 in an open position, as illustrated in FIG. 11A.

When it is desired to expand the length of the expandable edge-support members 150, a force can be placed on the non-planar portions 152 to cause the expandable enclosures 156 to collapse the interior 158, as illustrated in FIGS. 10B and 11B. If there is not a material disposed in the interior 158, the expandable enclosures 156 will simply collapse on themselves, as illustrated in FIG. 10B, to extend the length of the elongated member 154. If the composite material 160, for example, as illustrated in FIGS. 11A and 11B, is disposed in the interior 158 of the expandable enclosures 156, expansion of the expandable enclosures 156 will cause the interior walls of the expandable enclosures 156 to place a force on the composite material 160. This force will compress the composite material 160, as illustrated in FIG. 11B, to allow the length of the non-planar portions 152 to expand and the length of the elongated member 154 to expand as a result.

Similar to previous embodiments, the non-planar portions 152 can be disposed in the elongated members 154 between lateral members 162, as illustrated in FIGS. 10A-11B. This allows the distance between adjacent lateral members 162 to be expanded, similar to previous embodiments. For example, the distance between adjacent lateral members 162 in the elongated members 154 when the non-planar portion 152 has not been expanded is D₉, as illustrated in FIGS. 10A and 11A. When the non-planar portion 152 is expanded, the distance between adjacent lateral members 162 is distance D₁₀, as illustrated in FIGS. 10B and 11B. Thus, the non-planar portions 152 allow the distances between adjacent lateral members 162 to be expanded, as previously discussed. In the embodiments of FIGS. 11A and 11B, if the composite material 160 is more resilient than the material forming the elongated member 154, the inward force due to the resiliency of the composite material 160 may place a greater inward force between adjacent lateral members 162 when expanded. This may be desired depending on how much inward force is desired to be placed by the lateral members 162 on structures receiving the lateral members 162, such as coils of an innerspring for example.

Those skilled in the art will recognize improvements and modifications to the embodiments disclosed herein. Many modifications and other embodiments of the invention set forth herein will come to mind to one skilled in the art to which the invention pertains having the benefit of the teachings presented in the foregoing descriptions and the associated drawings. These modifications include, but are not limited to the type of edge-support, elongated member, and the number and type of expandable, integrated joints formed therein. Lateral members can be provided in the expandable edge-support members, but are optional and not required. If included, the number of lateral members can be varied as desired. The materials or compositions of the aforementioned components can be varied as well, including but not limited to whether exclusively thermoset or thermoplastic type materials, or a composite of both. All such improvements and modifications are considered within the scope of the concepts disclosed herein.

Further, it is to be understood that the embodiments are not to be limited to the specific embodiments disclosed and that modifications and other embodiments are intended to be included within the scope of the appended claims. It is intended that the embodiments cover the modifications and variations of this invention provided they come within the scope of the appended claims and their equivalents. Although specific terms are employed herein, they are used in a generic and descriptive sense only and not for purposes of limitation.

What is claimed is:

1. An edge-support member for providing bedding or seating edge support cushioning, comprising:
an elongated member; and
at least one expandable joint integrally formed in the elongated member;
wherein the at least one expandable joint is configured to expand in a length direction of the elongated member to allow the length of the elongated member to be expanded.

2. The edge-support member of claim 1, wherein the elongated member is formed out of at least one of a polymer, a polymer foam, latex, a viscoelastic, and a viscoelastic foam.

3. The edge-support member of claim 1, wherein the elongated member is formed of at least one polymer selected from the group consisting of a polystyrene, a polyolefin, a polyethylene, a polybutane, a polybutylene, a polyurethane, a polyester, an ethylene acrylic copolymer, an ethylene-vinyl-acetate copolymer, an ethylene-methyl acrylate copolymer, an ethylene-butyl-acrylate copolymer, an ionomer, a polypropylene, and copolymers of polypropylene.

4. The edge-support member of claim 1, wherein the at least one expandable joint is formed from a composite material.

5. The edge-support member of claim 4, wherein the composite material comprises at least one thermoset material and at least one thermoplastic material.

6. The edge-support member of claim 1, further comprising one or more channels disposed through the elongated member.

7. The edge-support member of claim 1, wherein the at least one expandable joint is comprised of a plurality of openings integrally formed in the elongated member.

8. The edge-support member of claim 7, wherein the plurality of openings are configured to be expanded to different sizes when a force is placed on the at least one expandable joint.

9. The edge-support member of claim 7, wherein a first opening among the plurality of openings is disposed on a top edge of the elongated member, and a second opening among the plurality of openings is disposed on a bottom edge of the elongated member.

10. The edge-support member of claim 7, wherein the plurality of openings form openings along length axes of the elongated member between a top edge and a bottom edge of the elongated member.

11. The edge-support member of claim 7, wherein the plurality of openings are disposed along a vertical axis of the elongated member.

12. The edge-support member of claim 7, wherein the plurality of openings are disposed along a plurality of vertical axes of the elongated member.

13. The edge-support member of claim 12, wherein the plurality of openings disposed between adjacent vertical axes among the plurality of vertical axes are disposed in different length axes of the elongated member.

14. The edge-support member of claim 12, wherein at least one opening among the plurality of openings in a first vertical axis among the plurality of vertical axes has a different width from at least one opening among the plurality of openings in a second vertical axis among the plurality of vertical axes.

15. The edge-support member of claim 7, wherein the plurality of openings are comprised of a plurality of punctures.

16. The edge-support member of claim 1, wherein the at least one expandable joint is comprised of at least one non-planar portion integrally formed in the elongated member.

17. The edge-support member of claim 16, wherein the at least one non-planar portion extends between a top edge and a bottom edge of the elongated member.

18. The edge-support member of claim 16, wherein the at least one non-planar portion includes at least one inflection plane.

19. The edge-support member of claim 16, wherein the at least one non-planar portion includes at least one S-shaped portion.

20. The edge-support member of claim 19, wherein the at least one S-shaped portion includes rounded edges.

21. The edge-support member of claim 19, wherein the at least one S-shaped portion includes rounded and flat edges.

22. The edge-support member of claim 16, wherein the at least one non-planar portion is comprised of at least one expandable enclosure having at least one interior.

23. The edge-support member of claim 22, wherein at least one compressible material is disposed in the at least one interior of the at least one expandable enclosure.

24. The edge-support member of claim 23, wherein the at least one compressible material is comprised of at least one composite material.

25. The edge-support member of claim 22, wherein the elongated member is comprised of a first material and the at least one explanable enclosure is comprised of at least one second material different from the first material.

26. The edge-support member of claim 1, further comprising:
a plurality of lateral members disposed in the edge-support member;
wherein the at least one expandable joint is disposed between adjacent lateral members among the plurality of lateral members.

27. The edge-support member of claim 26, wherein the at least one expandable joint is configured to allow a position of the plurality of lateral members to be adjusted with respect to each other.

28. The edge-support member of claim 27, wherein the at least one expandable joint is comprised of a plurality of openings integrally formed in the elongated member disposed between at least two lateral members among the plurality of lateral members.

29. The edge-support member of claim 28, wherein a first opening among the plurality of openings is disposed on a top edge of the elongated member, and a second opening among the plurality openings is disposed on a bottom edge of the elongated member.

30. The edge-support member of claim 28, wherein the plurality of openings form openings along length axes of the elongated member between a top edge and a bottom edge of the elongated member.

31. The edge-support member of claim 28, wherein the plurality of openings are disposed along a plurality of vertical axes of the elongated member.

32. The edge-support member of claim 31, wherein the plurality of openings disposed between adjacent vertical axes among the plurality of vertical axes are disposed in different length axes of the elongated member.

33. The edge-support member of claim 31, wherein at least one opening among the plurality of openings in a first vertical axis among the plurality of vertical axes has a different width from at least one opening among the plurality of openings in a second vertical axis among the plurality of vertical axes.

34. The edge-support member of claim 28, wherein the plurality of openings are comprised of a plurality of punctures.

35. The edge-support member of claim 28, wherein the at least one expandable joint is comprised of at least one non-planar portion integrally formed in the elongated member.

36. The edge-support member of claim 35, wherein the at least one non-planar portion extends between a top edge and a bottom edge of the elongated member.

37. The edge-support member of claim 35, wherein the at least one non-planar portion includes at least one S-shaped portion.

38. The edge-support member of claim 35, wherein the at least one non-planar portion is comprised of at least one expandable enclosure having at least one interior.

39. The edge-support member of claim 38, wherein at least one compressible material is disposed in the at least one interior of the at least one expandable enclosure.

40. The edge-support member of claim 35, wherein the at least one elongated member is comprised of a first material and the at least one non-planar portion is comprised of at least one second material different from the first material.

41. The edge-support member of claim 16, further comprising one or more channels disposed through the elongated member.

42. The edge-support member of claim 1, disposed around at least a portion of an edge portion of an innerspring.

43. The edge-support member of claim 26 disposed around at least a portion of an edge portion of an innerspring.

44. The edge-support member of claim 43, wherein the plurality of lateral members are disposed between adjacent perimeter coils of the innerspring.

45. The edge-support member of claim 43, wherein the innerspring comprises a plurality of interior coils and a plurality of perimeter coils disposed around a perimeter of the plurality of interior coils;
wherein the plurality of perimeter coils form at least two different spacings between a plurality of adjacent perimeter coils among the plurality of perimeter coils.

46. The edge-support member of claim 45, wherein a plurality of lateral members are disposed between the plurality of adjacent perimeter coils having the at least two different spacings.

47. The edge-support member of claim 45, wherein spacing between the plurality of lateral members is the same when the elongated member is not expanded, and wherein the spacing between the plurality of lateral members is not the same when the elongated member is expanded and disposed between the plurality of adjacent perimeter coils.

48. A method of constructing an edge-support member for providing bedding or seating edge support cushioning, comprising:
providing an elongated member; and
integrally forming at least one expandable joint in the elongated member;
wherein the at least one expandable joint is configured to expand in a length direction of the elongated member to allow the length of the elongated member to be expanded.

49. The method of claim 48, wherein integrally forming the at least one expandable joint comprises either extruding the at least one expandable joint from the elongated member or cutting the at least one expandable joint from the elongated member.

50. The method of claim 49, wherein extruding the at least one expandable joint comprises disposing a plurality of openings in at least one portion of the elongated member.

51. The method of claim 50, wherein disposing the plurality of openings comprises disposing the plurality of openings in the at least one portion of the elongated member along a vertical axis of the elongated member.

52. The method of claim 48, wherein integrally forming the at least one expandable joint comprises puncturing at least one portion of the elongated portion.

53. The method of claim 48, wherein integrally forming the at least one expandable joint comprises deforming at least one non-planar portion in the at least one portion of the elongated member.

54. The method of claim 53, wherein deforming the at least one non-planar portion comprises deforming the at least one non-planar portion in the at least one portion of the elongated member between a top edge and a bottom edge of the elongated member.

55. The method of claim 53, wherein deforming the at least one non-planar portion comprises deforming at least one S-shaped portion in the at least one portion of the elongated member.

56. The method of claim 48, further comprising forming at least one expandable enclosure having at least one interior in the at least one expandable joint.

57. The method of claim 56, further comprising disposing at least one compressible material in the at least one interior of the at least one expandable enclosure.

58. The method of claim 57, wherein the at least one compressible material is comprised of at least one composite material.

59. The method of claim 53, wherein the at least one elongated member is comprised of a first material and the at least one non-planar portion is comprised of at least one second material different from the first material.

60. An assembly for bedding or seating, comprising:
an innerspring having a perimeter;
an edge-support member disposed adjacent to at least a portion of the perimeter of the innerspring, wherein the edge-support member comprises:
an elongated member; and
at least one expandable joint integrally formed in the elongated member;
wherein the at least one expandable joint is configured to expand in a length direction of the elongated member to allow the length of the elongated member to be expanded.

61. The assembly of claim 60, wherein the at least one expandable joint is formed from a composite material.

62. The assembly of claim 60, further comprising one or more channels disposed through the elongated member.

63. The assembly of claim 60, wherein the at least one expandable joint is comprised of a plurality of openings integrally formed in the elongated member.

64. The assembly of claim 63, wherein the plurality of openings are disposed along a vertical axis of the elongated member.

65. The assembly of claim 63, wherein the plurality of openings are comprised of a plurality of punctures.

66. The assembly of claim 60, wherein the at least one expandable joint is comprised of at least one non-planar portion integrally formed in the elongated member.

67. The assembly of claim 66, wherein the at least one non-planar portion extends between a top edge and a bottom edge of the elongated member.

68. The assembly of claim 66, wherein the at least one non-planar portion is comprised of at least one expandable enclosure having at least one interior.

69. The assembly of claim 68, wherein at least one compressible material is disposed in the at least one interior of the at least one expandable enclosure.

70. The assembly of claim 60 further comprising:
a plurality of lateral members disposed in the edge-support member;
wherein the at least one expandable joint is disposed between adjacent lateral members among the plurality of lateral members.

71. The assembly of claim 70, wherein the at least one expandable joint is configured to allow a position of the plurality of lateral members to be adjusted with respect to each other.

72. The assembly of claim 70, wherein the plurality of lateral members are disposed between adjacent perimeter coils disposed in the perimeter of the innerspring.

73. The assembly of claim 70, wherein the innerspring comprises a plurality of interior coils and a plurality of perimeter coils disposed around a perimeter of the plurality of interior coils;
wherein the plurality of perimeter coils form at least two different spacings between a plurality of adjacent perimeter coils among the plurality of perimeter coils.

74. The assembly of claim 73, wherein a plurality of lateral members are disposed between the plurality of adjacent perimeter coils having the at least two different spacings.
